(19) United States
(12) Patent Application Publication
(10) Pub. No.: US 2008/0275646 A1
(43) Pub. Date: Nov. 6, 2008

(54) METHOD AND SYSTEM FOR MINIMAL DETOUR ROUTING WITH MULTIPLE STOPS

(76) Inventors: Chang-Shing Perng, Goldens Bridge, NY (US); Haixun Wang, Irvington, NY (US); Jian Yin, Bronx, NY (US); Xiaolan Zhang, Elmsford, NY (US)

Correspondence Address: Whitham, Curtis, & Christofferson, P.C., Suite 340, 11491 Sunset Hills Road, Reston, VA, 20190, US

(21) Appl. No.: 11/743,784

(22) Filed: May 3, 2007

(51) Int. Cl. G01C 21/32; G05D 1/00

(52) U.S. Cl. 701/210; 701/209; 701/202; 340/995.21

(57) ABSTRACT

The present invention provides a system and method for optimizing routes that include multiple stops. This is accomplished by allowing users to identify a starting point, a destination, and types of businesses or other locations to be visited along the way. A route processor then provides users with a list of stores or other requested detour choices yielding a trip of optimal itinerary. The detour choices may be either an ordered sequence or an unordered set of points to be visited and may include constraints that make it possible to optimize utility functions according to user preferences.

### BACKGROUND OF THE INVENTION

1. Field of the Invention

The present invention relates to information products that provide mapping and routing of trips.

2. Background Description

Map services like MapQuest, Yahoo! Map, and Google Local provide information products that allow users to specify a starting location and obtain a list of nearby businesses organized alphabetically or according to distance from the starting location. Many users and potential users of such information products, especially (but not exclusively) commuters, may find that such information products to be less than completely useful.

The most convenient business providers are not necessarily the ones that are closest to either work or home. For example, commuters moving between work and home on a daily basis have opportunities to stop along the way, and/or to take brief detours, to run errands. In some cases, an errand requires a stop at a particular store, restaurant, or government or professional office for which there is no substitute. In other cases, however, commuters may not have strong preferences for one potential supplier over another; for example, staples and commodities such as food and gasoline purchased at one location tend to be functionally identical to what is available at other locations, especially when the supplier is a large chain with many outlets. In intermediate cases, a commuter may have to visit, e.g., the state department of motor vehicles but may be indifferent as to whether the errand is done at one of several nearby offices of the department.

In cases where commuters do not have strong preferences for the goods or services of one supplier at one location over those of a supplier at another location, the most convenient supplier tends to be the one at the location that requires the shortest detour or no detour.

Currently, map services such as MapQuest, Yahoo! Map, and Google Local do not offer users the option of organizing information on local businesses according to the time required to travel a route that includes detours to stop for errands at various types of business (such as a dry cleaners, a grocery store, and/or a bookstore) along the way.

Using the existing art, the only way to accomplish this is manually to combine searches for local businesses with queries for point-to-point routing. This process is time-consuming and sufficiently tedious to be unattractive to consumers. In addition, use of such an ad-hoc process may not produce an optimal result.

### SUMMARY OF THE INVENTION

The present invention seeks to provide a solution to the inability of map services to provide appropriately optimized information. This is accomplished by: first, allowing users to specify a starting point and destination; then permitting users to specify types of businesses or other locations to be visited along the route; and, finally, providing users with a route based on a selection of stores or other requested detour choices which yield a trip of optimal itinerary. (The term “business” as used herein comprises all commercial locations and also includes, but is not limited to, noncommercial locations providing products or services, such as schools and government offices.)

The detour choices may include an ordered sequence or an unordered set of points to be visited. Users may elect to identify specific businesses at specific addresses so that the route may be optimized based, in part, on the need to stop at one or more specific addresses in addition to stopping at locations that may be selected based on business type. By permitting both ordered and unordered routing requirements, the present invention makes it possible to include constraints such as, e.g., a stop to pick up takeout food must be the last stop before reaching the end point so that the food does not get cold. Other optimizable utility functions may include, e.g., using traffic and road condition data to time the selection of a visit to a restaurant to approximate a preferred meal time or comparing the price of gas at a gas station with the cost (including, but not limited to, fuel consumption cost) of the detour required to stop there.

A routing service according to the present invention may provide a web interface, a telephone interface, an onboard automobile computer, a built-in or portable automobile navigation system, or another means for users to place queries and provide routing requirements.

After taking in the user-provided routing requirements, a routing service according to the present invention develops an optimal (or nearly optimal) route fulfilling those requirements and provides the route to the user. Thus, a routing service has available to it, at a minimum:
Map data (including, but not limited to GPS data) capable of being used to identify a start point, an end point, and a user's choices of types of businesses to be visited on detours from the route between the start point and the end point; and
Business data including, but not limited to:
   Data classifying businesses by type and
   Data identifying businesses by location of businesses, such that user-provided input of business type may be used to identify businesses of the requested type near the user's proposed route from start point to end point.
      In addition, routing requirements may further employ:
User data, including, but not limited to, user preferences as to whether routing should be optimized by time, fuel economy, and/or other factors, as well as data (including, but not limited to, nominal, historical, and/or real-time fuel consumption data for a user's automobile) needed to perform such optimization; and
External constraint data, including, but not limited to, data on current gasoline prices and/or current traffic conditions.

The present invention may be implemented by use of a computer or other data processing apparatus, including, but not limited to:
A conventional desktop PC, such as one used to obtain and print out an itinerary and directions by querying an online mapping service;
A server made available to users via a remote terminal (e.g., through an web browser or through a cellular or land-based telephone system);
A computer either integrated into a vehicle as an onboard computer or (as may be done with a laptop PC, a personal digital assistant, or an advanced cellular telephone) temporarily connected to a vehicle by a wired or wireless networking capability; or
Another data processing apparatus configured to implement the present invention, including, but not limited to, a built-in or portable automobile navigation system.

The data provided for processing according to the present invention may be input manually or provided in an automated format. A computer or other data process device used according to the present invention will be required to process:
Geographic data as to departure and destination points of a vehicle (with the departure point in some cases defined as a user's current location based on data being reported from a GPS system);
Business data identifying by business type the detours that are to be made en route between the start point and the end point of a trip (e.g., to visit a grocer, pharmacy, department of motor vehicles, pizzeria, etc. on a trip from work to home); and
Business data cross-referencing businesses by business type and business location.
   Various additional types of data may also be selected for processing according to the present invention, including, but not limited to:
User data, including, but not limited to
   Automobile data, including, but not limited to, automobile location data and automobile performance data,
   User-provided preference data, including, but not limited to, user choices on whether to optimize by time, fuel economy, and/or other factors as well as data needed to perform such optimization), and/or user preferences favoring or disfavoring certain vendors such as restaurants, etc.
   User-imposed constraint data, including, but not limited to, whether there is a sequence in which some or all detours must occur (e.g., pizzeria must be the last stop before home, gas station must be visited before picking up guests while restaurant must be visited after picking up guests, or gift store must be visited before post office); and
External constraint data (external data), including, but not limited to:
   Traffic data, including, but not limited to, data which may be used in conjunction with automobile data to determine transit times between one point and another en route,
   Fuel data, including, but not limited to, fuel price data which may be used in conjunction with automobile data to determine fuel consumption between one point to another en route,
   Preference data to enable a preferred business to be selected ahead of a nonpreferred business when other criteria are equivalent, including, but not limited to, advertiser-sponsored programs to favor one business over another when both businesses meet a user's criteria.
   Other travel data, including, but not limited to, data on road conditions and/or data on the cost of any tolls that must be paid en route, etc., and
   Other data, including, but not limited to, third-party quality ratings on restaurants and/or other suppliers.

At least one route processor then processes data to determine a route that is optimized according to user requirements. The optimized route is provided as output in a useful format, which may include, but is not limited to:
A paper document, including, but not limited to, a printout from a printer connected to a conventional PC or a printout mailed or otherwise delivered to a user from a remote document processing facility;
An electronic document, including, but not limited to, an email or an electronic document attached to an email;
An on-screen display, including, but not limited to, information provided on the display screen of an onboard automobile computer, a computer networked to an automobile, or a built-in or portable automobile navigation device;
An audio message in natural language format enabling routing information to be provided to a driver via, e.g., a cellular or land-based telephone handset.
An audio message in natural language format enabling routing information to be provided en route to a driver using an onboard automobile computer, a computer networked to an automobile, or a portable automobile navigation device to receive information without requiring the driver to look away from the road); and/or
Machine-readable data provided directly to an onboard data processing system, e.g., to provide routing information to a fully automated or robotic vehicle.

The present invention thus provides a method and a system for optimizing a route with a plurality of detours, comprising the steps of:
(a) using at least one computer or other data processor to receive, as input, (i) map data, (ii) a start point and an end point described according to said map data, wherein said start point and end point are different from each other, (iii) at least one constraint requiring a route between the start point and the end point to include, or pass through, at least one selected intermediate point, (iv) detour type data identifying by type at least one detour to be accomplished on a route between the start point and the end point, and data cross referencing detour type and detour location;
(b) using at least one computer or other data processor to determine an optimized route by (i) using said cross referencing data to determine the presence of any detours of requested type on or near the route and, if so, whether multiple alternative detour locations are present, (ii) when multiple alternative detour locations are present, using preference data to determine whether any of said detour locations is to be preferred over any other of said detour locations, and (iii) determining an optimized route, identifying a sequence and of detour locations between the start point and the end point; and
(c) using at least one computer or other data processor to provide said optimized route as output, with the optimized route starting at the start point and ending at the end point and also satisfying the constraint (requiring the route to include, or pass through, at least one selected intermediate point) and optimizing a given object function. The object function may be the length of a route on a map or another object function or functions.

The start point and the end point may be points on a map. The selected intermediate point may be one of a set of points of the same type, any of which points will satisfy said constraint. A failure to satisfy the constraint may result in an unfavorable change in the value of the route as reflected in the object function, thus making a choice that does not satisfy the constraint less preferable than a choice that does satisfy the constraint. The constraint may be a requirement for the route to pass through a plurality of intermediate points, each of the intermediate points being of a different type from the other intermediate points and each of the intermediate points being selected from among a plurality of candidate points of the same type. In addition, the constraint may be a requirement for the route to include, or pass through, a plurality of intermediate points of different types, each such point being of one of a plurality of types, which plurality of types is a subset of all available types, and no such point being of the same type as another point to be included on the route.

The present invention may enable a user to require that at least two detours must occur in a user-specified sequence along said route. Determining whether any of the detour locations is to be preferred over any the other detour locations may comprise assigning a preference value to each of said detour locations and comparing the preference values of each detour location. Preference data may further comprise:
Data on the automobile being used to travel the route
Data on user preferences on whether the route is to be optimized by travel time and/or by fuel economy
User-defined preference data
Advertiser-defined preference data
External constraint data, which may comprise
   Road condition data and/or traffic data,
   Fuel price data and/or vehicle fuel consumption data,
   Data on the cost of tolls that must be paid along the route, and/or
   Data on other external constraints.

Machine-readable instructions may be stored on a machine-readable medium to instruct a computer or other data processing apparatus to perform steps according to the method of the present invention.

A system made according to the present invention may receive data (i) via a global positioning satellite system and/or (ii) from one or more databases. In a system according to the present invention, one or more databases may be connected to the route processor by network, and that network may or may not be a wireless network. Output provided according to the system of the present invention may be presented as a visual display, as an audio message, as a printable document, as machine readable data, and/or in another format.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a representation of an automobile equipped with the present invention.

FIG. 2 is a representation of an exemplary embodiment of the present invention.

FIG. 3 is a representation of a route with several stops according to the present invention.

FIG. 4 is a representation of a route computed according to the present invention.

### DETAILED DESCRIPTION OF A PREFERRED EMBODIMENT OF THE INVENTION

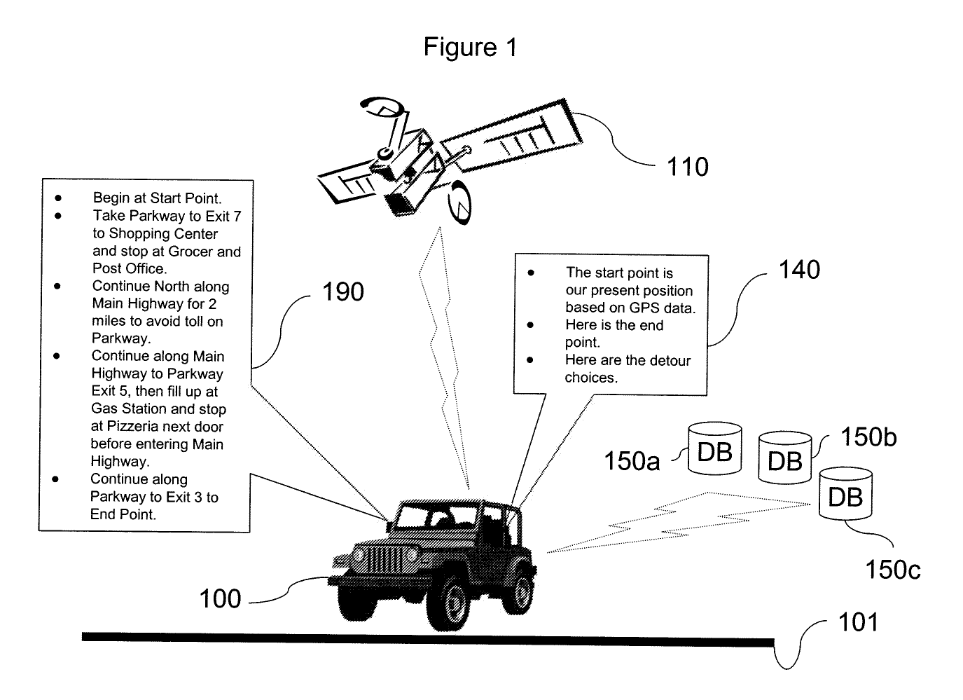

Referring now to the drawings, and more particularly to FIG. 1, there is shown an onboard-computer-equipped automobile 100 traveling along a road 101. The automobile receives GPS data from a satellite 110 from which start point may be determined without data input by the driver. End point and detour choices are input using a natural language system 140. Business data, user preferences, and constraint data may be received from any of a plurality of onboard or wirelessly networked databases 150a, 150b, 150c. The automobile's integrated onboard computer processes the data and determines an optimized route, which is provided to the driver in natural language format through the automobile's audio system 190.

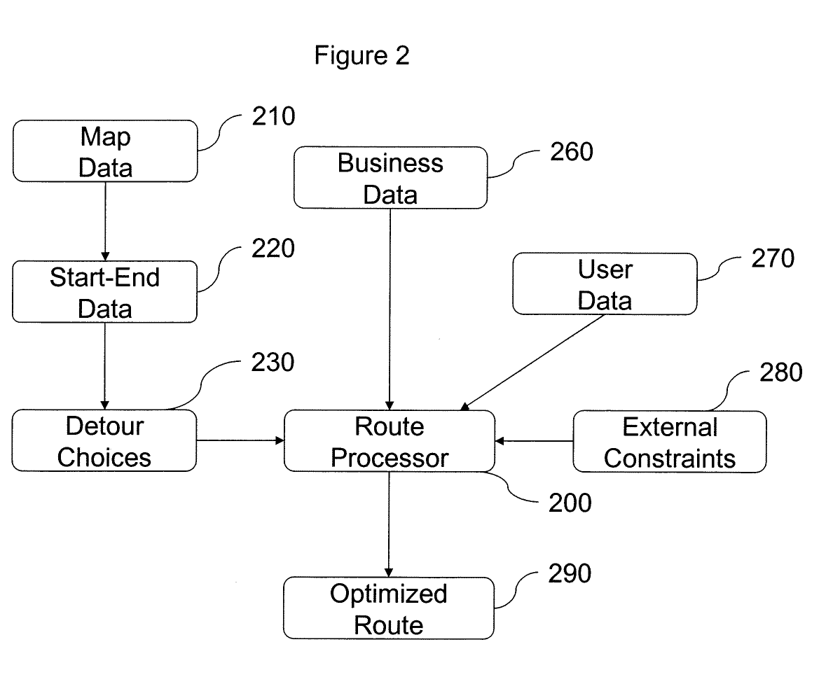

Referring now to FIG. 2, there is shown a route processor 200 receiving map data 210 and start point-end point (start-end) data 220. The route processor 200 also receives detour choice data 230 identifying types of businesses to be visited along the route. The route processor 200 determines an optimized route 290 by comparing these data to business data 260 which includes data cross-referencing business type and business location, user data 270, and external constraint data 280 to determine an optimized route. Once an optimized route has been determined according to choices and preferences provided by the user, the optimized route 290 is provided to the user as output.

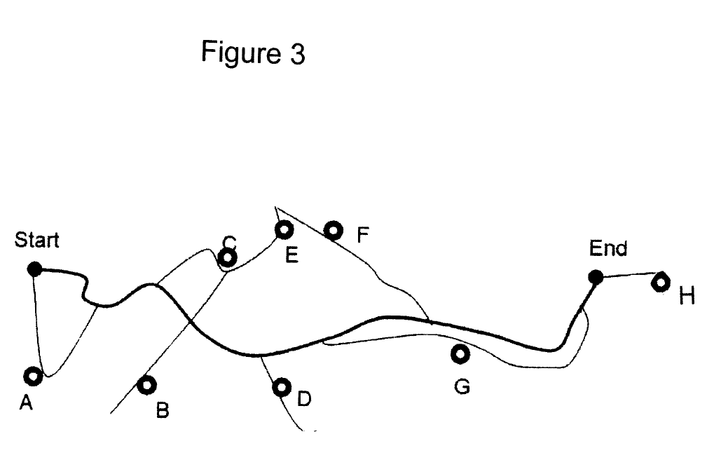

Referring now to FIG. 3, there is shown a route from Start to End, with intermediate stops A, B, C, D, E, F, G, and H along the way.

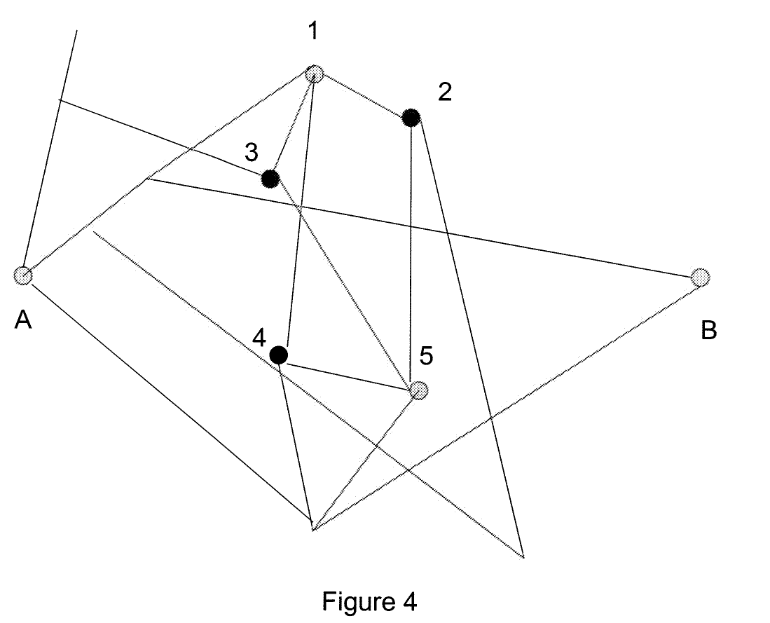

In FIG. 4, the present invention computes a route from point A to point B. The route is composed of a set of roads which are represented as lines. Each line can have labels describing the length of the road, the time required to travel the road, the probability of the road getting congestion, and so on.

In this example, an object function F can be one or any combination of the following:
The total length of the route from A to B,
The amount of time to travel from A to B,
The average amount of time to travel from A to B,
The variance of the amount of the time to travel from A to B, and/or
The possibility that the travel time from A to B exceeds a certain threshold T.

By way of example, but not limitation, exemplary constraints can be one or any combination of the following:
(1) The route has to go through one type of stops (such as a supermarket) which is presented as black dots and includes points 2, 3, and 4.
(2) It is possible for the route not to go through supermarkets, but that will introduce some penalty to the object function F and thus make it less desirable.
(3) The route has to go through another type of stops (such as gas stations) which is represented as red dots if the route from the start point has to exceed a certain length (or time, or other constraints).
(4) The route must not go through certain type of stops (such as accident sites). Or the route can go through those kind of dots, but it will introduce certain penalty.

Take, as an example, the case in which a user inputs the U.S. Capitol in Washington, D.C., as start point A and the U.S. Patent and Trademark Office in Alexandria, Va., as end point B, with minimization of the amount of time to travel from A to B as the object function F and the added constraints that the route must pass by a supermarket but should avoid accident sites (i.e., it will incur penalties if it goes through an accident site). If points 2, 3, and 4 are supermarkets, and points 1 and 5 are accident sites, then a route passing by grocery stores 3 and 4 may be preferred over a route passing by grocery store 2, because accident sites 1 and 5 are en route to grocery store 2, except via routes that pass by grocery stores 3 or 4 before passing by grocery store 2. Optimization of the choice between grocery store 3 and grocery store 4 may be made be based on data enabling comparisons of traffic speeds along different routes. In rare cases, the travel time required to pass by grocery stores 3 or 4 may be so great that, the optimized route will pass by grocery store 2, even with the penalty for passing by an accident site. This would occur when the routes passing by grocery stores 3 and 4 are so congested that the penalty for passing by accident sites 1 or 5 is not great enough to offset the loss from choosing more time-consuming routes passing by grocery stores 3 or 4. The present invention can thus take multiple constraints and object functions into account to determine an optimized route.

While the invention has been described in terms of a set of preferred embodiments, those skilled in the art will recognize that the invention can be practiced with modification within the spirit and scope of the appended claims.

Having thus described our invention, what we claim as new and desire to secure by Letters Patent is as follows:

1. A method for optimizing a route with a plurality of detours, comprising the steps of:
using at least one computer or other data processor to receive as input:
a start point,
an end point, and
at least one constraint requiring a route between said start point and said end point to pass through at least one selected intermediate point; and
using at least one computer or other data processor to provide as output a route that starts at said start point, ends at said end point, satisfies said constraint, and optimizes a given object function.

2. The method of claim 1, wherein said start point and said end point are points on a map.

3. The method of claim 1, wherein said object function is the length of a route on a map, which is to be minimized.

4. The method of claim 1, wherein the selected intermediate point is a member of a set of points of the same type, each of said points satisfying the constraint.

5. The method of claim 1, wherein a failure to satisfy the constraint results in an unfavorable change in the route's value as reflected in the object function, thus reducing the preferability of a route that includes a choice that fails to satisfy the constraint.

6. The method of claim 1, wherein said constraint is a requirement for the route to pass through a plurality of intermediate points, each of said intermediate points being of a different type from the other intermediate points and each of said intermediate points being selected from among a plurality of candidate points of the same type.

7. The method of claim 1, wherein the constraint is a requirement for the route to include, or pass through, a plurality of intermediate points of different types, each such point being of one of a plurality of types, which plurality of types is a subset of all available types, and no such point being of the same type as another point to be included on the route.

8. A system for optimizing a route with a plurality of detours, comprising:
at least one route processor receiving as input:
a start point,
an end point, and
at least one constraint requiring a route between said start point and said end point to pass through at least one selected intermediate point; and
said at least one route processor providing as output a route that starts at said start point, ends at said end point, satisfies said constraint, and optimizes a given object function.

9. The system according to claim 8, wherein said start point and said end point are points on a map;

10. The system according to claim 9, wherein said map points are determined according to a global positioning satellite system.

11. The system according to claim 8, wherein data describing said points is received from one or a plurality of databases connected to said route processor by a network.

12. The system of claim 8, wherein said object function is the length of a route on a map, which is to be minimized.

13. The system of claim 8, wherein the selected intermediate point is a member of a set of points of the same type, each of said points satisfying the constraint.

14. The system of claim 8, wherein a failure to satisfy the constraint results in an unfavorable change in the route's value as reflected in the object function, thus reducing the preferability of a route that includes a choice that fails to satisfy the constraint.

15. The system of claim 8, wherein said constraint is a requirement for the route to pass through a plurality of intermediate points, each of said intermediate points being of a different type from the other intermediate points and each of said intermediate points being selected from among a plurality of candidate points of the same type.

16. The system of claim 8, wherein said constraint is a requirement for the route to pass through a plurality of intermediate points of different types, each such point being of one of a plurality of types, which plurality of types is a subset of all available types, and no such point being of the same type as another point to be included on the route.

17. The system according to claim 8, wherein said output is provided as a visual display.

18. The system according to claim 8, wherein said output is provided as an audio message.

19. The system according to claim 8, wherein said output is provided as machine-readable data.

20. A machine-readable medium for optimizing a route with a plurality of detours, on which are provided:
machine-readable instructions for at least one computer or other data processor to receive as input:
a start point,
an end point, and
at least one constraint requiring a route between said start point and said end point to pass through at least one selected intermediate point; and
machine-readable instructions for at least one computer or other data processor to provide as output a route that starts at said start point, ends at said end point, satisfies said constraint, and optimizes a given object function.
